(19) United States
(12) Patent Application Publication
(10) Pub. No.: US 2012/0262396 A1
(43) Pub. Date: Oct. 18, 2012

(54) OPERATION APPARATUS

(75) Inventors: Motoya JIYAMA, Kobe-shi (JP); Naoki SUGAMOTO, Kobe-shi (JP); Nobuyuki BATOU, Kobe-shi (JP); Kiyoshi HAMATANI, Kobe-shi (JP); Kohji MIYAZATO, Kobe-shi (JP); Hiroyuki YANAI, Kobe-shi (JP); Sadaharu YAMAMOTO, Osaka-shi (JP)

(73) Assignee: FUJITSU TEN LIMITED, Kobe-shi (JP)

(21) Appl. No.: 13/444,492

(22) Filed: Apr. 11, 2012

(30) Foreign Application Priority Data
Apr. 13, 2011 (JP) 2011-089442

(51) Int. Cl. G06F 3/041

(52) U.S. Cl. 345/173

(57) ABSTRACT

An operation apparatus that receives a pressing operation by a user on a surface of a touch panel derives a pressing point based on pressure values at a plurality of positions of the touch panel, and corrects the derived pressing point based on a pressing direction relative to the surface of the touch panel.

### BACKGROUND OF THE INVENTION

1. Field of the Invention

The invention relates to a technology that receives an input operation of touch on an operation surface.

2. Description of the Background Art

A conventionally-known operation apparatus receives an input operation on an operation surface of a touch panel. The operation apparatus detects a pressing point by various systems such as a pressure sensitive system that senses pressure, and a capacitance sensing system that senses change in the capacitance between a finger and a conducting layer.

Japanese Patent Application Laid-open Publication No. 2006-126997 discloses a touch panel of the pressure sensitive system that calculates a pressing point based on the pressure values detected by the pressure sensors installed at the four corners of the back side of the touch panel.

However, the touch panel disclosed in Japanese Patent Application Laid-open Publication No. 2006-126997 has a problem. When the touch panel is pressed from a diagonal direction to the surface of the touch panel, an erroneous pressing point may be detected by the influence of the pressing force from the oblique direction to the surface of the touch panel.

In an example, the touch panel that is included in the ticket machine installed at a railway station is mostly pressed almost from the front. On the other hand, the operation apparatus that is installed in a vehicle and includes a navigation function is not always set just in front of a driver seat or a passenger seat. Since the operation apparatus is commonly pressed from the diagonal direction to the surface of the touch panel, such an operation apparatus installed in a vehicle has a major problem of the erroneous detection.

Here is another example of the problem on the operation apparatus that judges whether a pressing force is weak or strong and implements an operation corresponding to the pressing force. The operation apparatus judges A operation when receiving a weak pressing force and B operation when receiving a strong pressing force. However, the operation apparatus may perform an unexpected behavior because the actual pressing force by a user is not accurately detected by the influence of a pressing direction. Here, the pressing direction is the direction from which pressing is done to the surface of the touch panel.

Therefore, the major task here is how to implement such an operation apparatus that can prevent erroneous detection of a pressing point even when receiving pressing operation from the diagonal direction to the surface of the touch panel.

### SUMMARY OF THE INVENTION

According to one aspect of the invention, an operation apparatus that receives a pressing operation by a user on a surface of a touch panel includes a plurality of detectors that detect pressure values at a plurality of positions of the touch panel, the pressure values being generated at a time of the pressing operation, a controller configured to derive a pressing point based on the pressure values detected by the detectors, and a first memory that stores pressing point correction data to correct the derived pressing point in association with a pressing direction relative to the surface of the touch panel, wherein the controller is configured to correct the derived pressing point based on the pressing point correction data stored in the first memory.

This prevents erroneous detection of the pressing point even when the operation apparatus receives the pressing operation by a user from a diagonal direction relative to the surface of the touch panel.

According to another aspect of the invention, an operation apparatus that receives a pressing operation by a user on a surface of a touch panel includes a controller configured to derive a pressing force based on the pressure values detected by the detectors, and a second memory that stores pressing force correction data to correct the derived pressing force in association with the pressing direction relative to the surface of the touch panel, wherein the controller is configured to correct the derived pressing force based on the pressing force correction data stored in the second memory.

This prevents erroneous detection of the pressing force even when the operation apparatus receives the pressing operation by a user from a diagonal direction relative to the surface of the touch panel.

Therefore, the object of the invention is to prevent erroneous detection of a pressing point and a pressing force when an operation apparatus receives a pressing operation from a diagonal direction to a surface of a touch panel.

These and other objects, features, aspects and advantages of the invention will become more apparent from the following detailed description of the invention when taken in conjunction with the accompanying drawings.

### BRIEF DESCRIPTION OF THE DRAWINGS

FIG. 1A shows an overview of an operation apparatus of the embodiment.

FIG. 1B shows another overview of the operation apparatus of the embodiment.

FIG. 1C shows another overview of the operation apparatus of the embodiment.

FIG. 1D shows another overview of the operation apparatus of the embodiment.

FIG. 2 shows a navigation apparatus configuration diagram of the embodiment.

FIG. 3A shows an example of installation locations of pressure sensors and direction-detection pressure sensors.

FIG. 3B shows another example of the installation locations of the pressure sensors and the direction-detection pressure sensors.

FIG. 3C shows another example of the installation locations of the pressure sensors and the direction-detection pressure sensors.

FIG. 4 shows an example of a correction table and an example of correction data.

FIG. 5A describes a right time for correction value adjustment.

FIG. 5B describes another right time for correction value adjustment.

FIG. 5C describes another right time for correction value adjustment.

FIG. 6 shows an overview process flowchart for timing decision.

FIG. 7 shows an overview process flowchart for correction value adjustment.

FIG. 8 shows an overview process flowchart for pressing point correction.

FIG. 9 describes a learning function for correction values.

### DESCRIPTION OF THE EMBODIMENTS

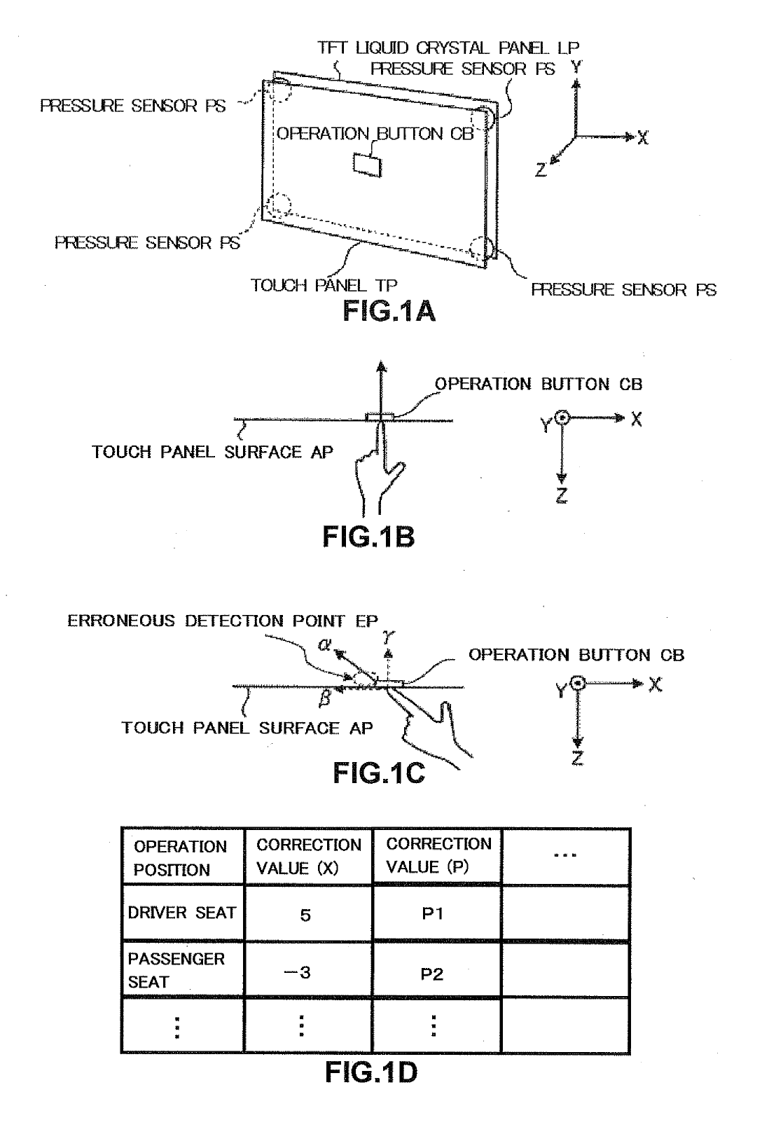

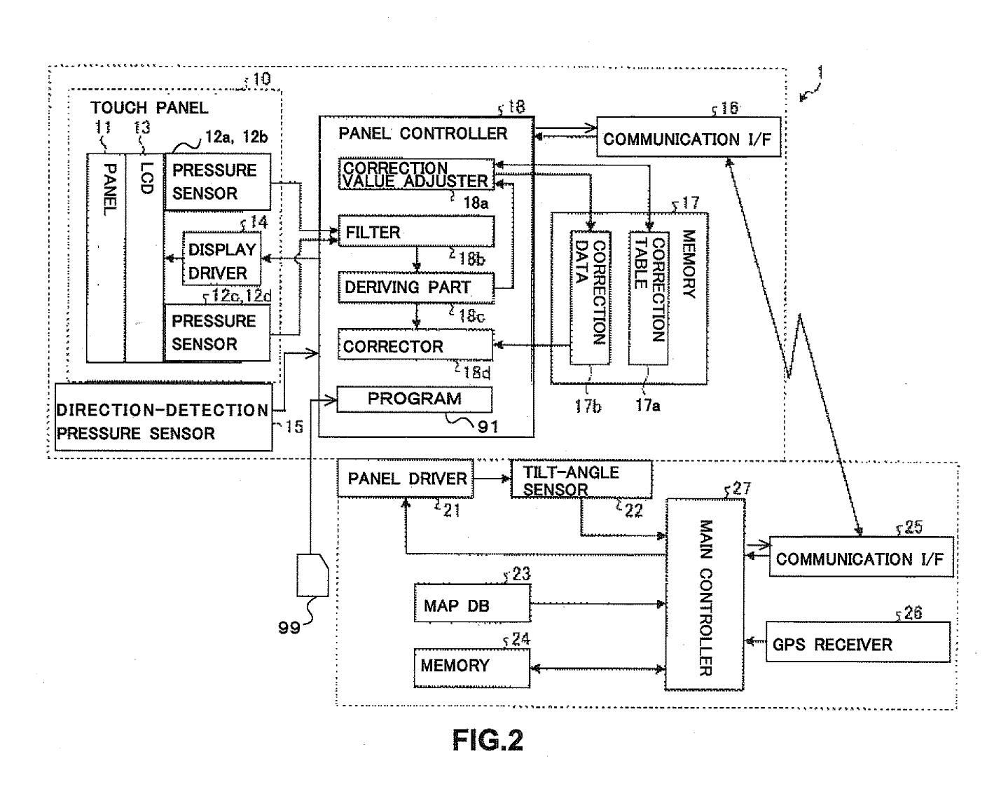

Based on attached drawings, an embodiment of an operation apparatus of the invention is described. First, the overview of the operation apparatus of the invention is described based on FIG. 1. Next, the details of the embodiments are described based on FIG. 2 to FIG. 9. The embodiment of the invention applied to the navigation apparatus is described below.

Each of FIG. 1A, FIG. 1B, FIG. 1C and FIG. 1D shows an overview of an embodiment of an operation apparatus of the invention. The operation apparatus derives a pressing point based on the pressure values detected by pressure sensors, and corrects the derived pressing point in accordance with a pressing direction.

In an example, the operation apparatus makes two types of corrections: one for the case where a touch panel is pressed from a right-diagonal direction to the surface of the touch panel; and the other for the case where the touch panel is pressed from a left-diagonal direction. These corrections prevent on the operation apparatus the erroneous detection of the pressing point and a pressing force even in the case where the touch panel is pressed from the diagonal direction to the surface of the touch panel.

FIG. 1A shows the touch panel of the operation apparatus viewed from a right-above angle. Each of FIG. 1B and FIG. 1C shows the touch panel of the operation apparatus viewed from above. FIG. 1D shows an example of correction data for pressing point correction. Some parts of the description below use coordinate axes shown in FIGS. 1A to 1C when needed.

As shown in FIG. 1A, a pressure sensor PS is deployed at each of the four corners of the back of a touch panel TP that is included in the operation apparatus installed in a vehicle and that receives a pressing operation. Various types of operation buttons CB are displayed on a TFT (Thin Film Transistor) liquid crystal panel LP that is installed in such a way that the four pressure sensors PS are sandwiched between the touch panel TP and the TFT liquid crystal panel LP.

In FIG. 1A, FIG. 1B and FIG. 1C, the front side of the touch panel TP is shown in a positive Z-axis direction. The operation apparatus receives an input operation with a touch of user's finger (pressing operation) on the touch panel TP and derives the pressing point and the pressing force based on the four pressure values of the pressing operation detected by the four pressure sensors PS.

As the overview of the operation apparatus, the ratio of the distances from the pressure sensors PS to the pressing point is inversely related to the pressure value detected by each of the pressure sensor PS. The operation apparatus derives the pressing point by processing the values detected by the pressure sensors PS based on the arithmetic expression and the table based on the inverse relations. Since the pressing force is divided and detected by each of the pressure sensors PS, the operation apparatus also derives the pressing force based on the pressure values (the sum of the values) detected at each of the pressure sensors PS.

As shown in FIG. 1B, pressing the center of the operation button CB from the front of a touch panel surface generates only the stress vertical to the touch panel surface AP. Thus, the operation apparatus accurately derives the center of the button as the pressing point, and the pressing force to the touch panel surface AP as well.

However, when the operation button CB is pressed from the oblique direction to the touch panel surface AP as shown in FIG. 1C, the point derived by the operation apparatus as the pressing point is not identical with the actual pressing point. Moreover, the force derived by the operation apparatus as the pressing force is also not identical with the actual pressing force. The details are as follows.

In an example on the operation apparatus installed in the front between a driver seat and a passenger seat, when the operation apparatus is pressed from the direction of the driver seat (here, it is shown in a positive X-axis direction), the operation button CB is pressed from the oblique direction to the touch panel surface AP. That is, the touch panel surface AP receives the stress at the center of the operation button CB to the direction shown as a vector α.

The stress shown as the vector α is divided into a vector β of a negative X-axis direction and a vector γ of a negative Z-axis direction. The relation among the vector α, the vector β and the vector γ is shown in a formula (1).

vector α=vector β+vector γ (1)

As above, when the operation button CB is pressed from the direction of the driver seat, the operation apparatus receives a lateral stress (vector β) to the touch panel surface AP as well as the vertical stress (vector γ) to the touch panel surface AP, the vertical stress being required for pressing point detection, and each of the pressure sensors PS is affected by the stress of the vector β. Thus, the operation apparatus detects an erroneous point away from the actual pressing point in the direction of the vector β as the pressing point.

As above, in an example, the operation apparatus derives an erroneous detection point EP that is out of the area of the pressed operation button CB as the pressing point, as a result, the operation apparatus does not function as desired by the driver.

Moreover, even when the same pressing force is applied at the same point, the pressure detected by each of the pressure sensors PS differs by the applied pressing direction (angle between the pressed direction and the vertical direction to the touch panel surface). As a result, the operation apparatus does not function in terms of the behavior corresponding to the pressing force as desired by the driver.

To respond to the problem, the operation apparatus of the invention stores the correction values associated with the pressing directions as correction data, and corrects the pressing point based on the correction data. Concretely, as shown in FIG. 1D, the operation apparatus of the invention stores as the correction data in association with the item of “operation position” the item of “correction value (X)” relevant to the detected pressing point and the item of “correction value (P)” relevant to the pressing force.

The item of “operation position” specifies the pressing directions that have two types: the direction from the driver seat and the direction from the passenger seat. The items of “correction value (X)” and “correction value (P)” specify the correction values based on previously assumed values.

The operation apparatus corrects the pressure values detected by the respective pressure sensors PS based on the correction value in the item of “correction value (P),” derives the pressing point based on the corrected pressure values, and then corrects the derived pressing point based on the correction value in the item of “correction value (X).” As shown in the item of “correction value (X),” only the correction value in the X-axis direction is taken into account here. However, the correction value in the Y-axis direction may be taken into account as well.

In an example, in the case where the operation apparatus of the embodiment is pressed from the direction of the driver seat and the coordinate of the derived pressing point is (x, y), the coordinate of the pressing point may be corrected into (x+5, y) or into (x+5, y+2) with additional correction of Y-axis direction based on the correction data. The operation apparatus may store only the correction data associated with the operation position of the driver seat. In this case, the correction data does not need the item of “operation position.”

As above, the operation apparatus of the embodiment corrects the pressing point derived based on the pressure values detected by the four pressure sensors PS by use of the correction data associated with the pressing direction and the pressing force. This prevents erroneous detection of the pressing point even in the case where the touch panel is pressed from the oblique direction to the touch panel surface AP.

On the embodiment, the operation apparatus stores the correction values as the correction data for correction. However, the operation apparatus may store an arithmetic expression as correction data for the correction. In this case, the arithmetic expression for correction may use parameters converted from tilt levels and the operation positions. There is another adaptable method where the operation apparatus stores the arithmetic expression partially based on the parameters of the tilt levels and the operation positions, and calculates the arithmetic expression by use of other parameters.

The operation apparatus of the invention stores, as the correction data, the correction values based on the previously assumed values. The operation apparatus may obtain the pressing point actually pressed by a user, adjust the correction values based on the comparison between the obtained pressing point and the center of the reference button (hereinafter, referred to as “calibration”), and may store the adjusted correction values as the correction data.

The calibration may be implemented at the time of shipment of the operation apparatus (in the adjustment process at a factory) or installation of the operation apparatus in a vehicle. The correction data may be set depending on users' needs.

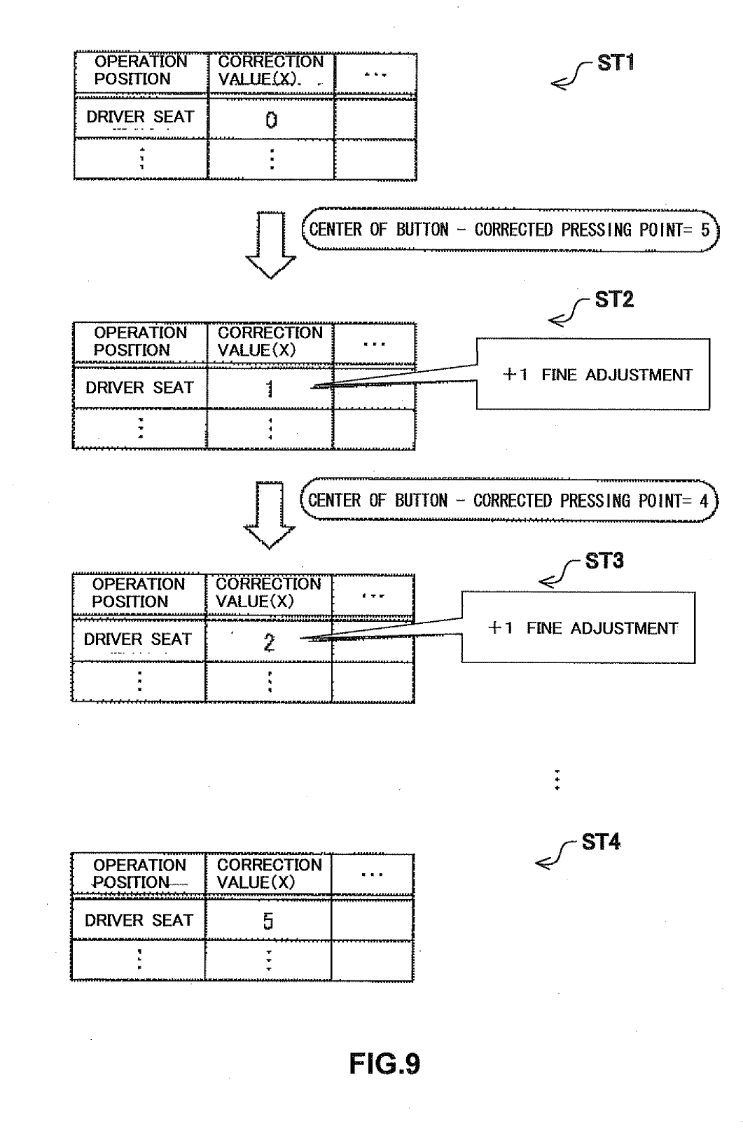

The contents obtained by learning of the differences between the derived pressing points and the center of the button occurred at the times of users' operations may be utilized for change of the correction values. The details of the learning are described later based on FIG. 9.

On many operation apparatus for sale lately, the touch panel surfaces are adjustable in various angles (hereinafter, referred to as tilt angles). Thus, the operation apparatus of the embodiment may store as correction data the correction values or the arithmetic expression in association with the tilt angles not only with the pressing directions. The details of the correction data associated with the tilt angles are described later.

Here, the details of the operation apparatus in FIGS. 1A to 1D are described. The embodiment of the operation apparatus applied to the navigation apparatus is described. However, the operation apparatus of the invention may be applied to other apparatus.

First, the configuration of a navigation apparatus 1 of the embodiment is described based on FIG. 2. FIG. 2 shows the configuration diagram of the navigation apparatus 1. Here, FIG. 2 shows only the components required for description of the characteristics of the navigation apparatus 1.

As shown in FIG. 2, the navigation apparatus I of the embodiment includes a panel 11, a pressure sensor 12a, a pressure sensor 12b, a pressure sensor 12c and a pressure sensor 12d, a LCD (Liquid Crystal Display) 13, a display driver 14, a direction-detection pressure sensor 15, a communication I/F (interface) 16, a memory 17 and a panel controller 18. The memory 17 stores a correction table 17a and correction data 17b.

The panel controller 18 includes a correction-value adjuster 18a, a filter 18b, a deriving part 18c and a corrector 18d. The panel controller 18 has a computer including a CPU (Central Processing Unit), a RAM (Random Access Memory) and a ROM (Read Only Memory). The panel controller 18 implements various controls through processing of the CPU in accordance with a program 91 that has been prescribed and stored in the ROM. The navigation apparatus 1 may read out the program 91 for acquisition via a reader not shown in FIG. 2 from a non-transitory computer-readable recording medium 99 that stores programs, such as a memory card.

Further, the navigation apparatus 1 includes a panel driver 21, a tilt-angle sensor 22, a map DB (DataBase) 23, a memory 24, a communication I/F 25, a GPS (Global Positioning System) receiver 26 and a main controller 27.

The panel 11 is a board member made of transparent material such as glass. The front surface of the panel 11 functions as an operation surface that receives the pressing operation by a user. As described based on FIG. 1A, the pressure sensors 12a to 12d are respectively installed at the four corners of the back of the panel 11.

Each of the pressure sensors 12a to 12d is the detector that detects the load of the pressing operation on the panel 11 pressed by a user, and that is implemented, for example, by a piezoelectric element. The detection values detected by the pressure sensors 12a to 12d are respectively input to the filter 18b.

The LCD 13 that has a plurality of pixels disposed in a matrix displays an image by modulating the light emitted from a prescribed light source on a pixel to pixel basis based on the control signal from the display driver 14. The display driver 14, such as a LCD driver, acquires image data from the panel controller 18 for display of the image based on the acquired image data on the LCD 13.

The example of a touch panel 10, as shown in FIG. 2, includes the panel 11, the pressure sensors 12a to 12d, the LCD 13 and the display driver 14. FIG. 2 shows the pressure sensor 12a, the pressure sensor 12b, the pressure sensor 12c and the pressure sensor 12d that are deployed at the four corners of the back of the panel 11. As a general term of all the pressure sensors 12a to 12d, “pressure sensors 12” is used.

The direction-detection pressure sensor 15 that is installed at the back of the panel 11 detects the pressing direction of the pressing operation applied on the panel 11. That is, the direction-detection pressure sensor 15 is a pressure sensor that detects the pressing direction. The direction data that indicates the direction detected by the direction-detection pressure sensor 15 is transmitted to the corrector 18d. The corrector 18d corrects the pressing point based on the correction data 17b associated with the detection direction indicated by the received direction data.

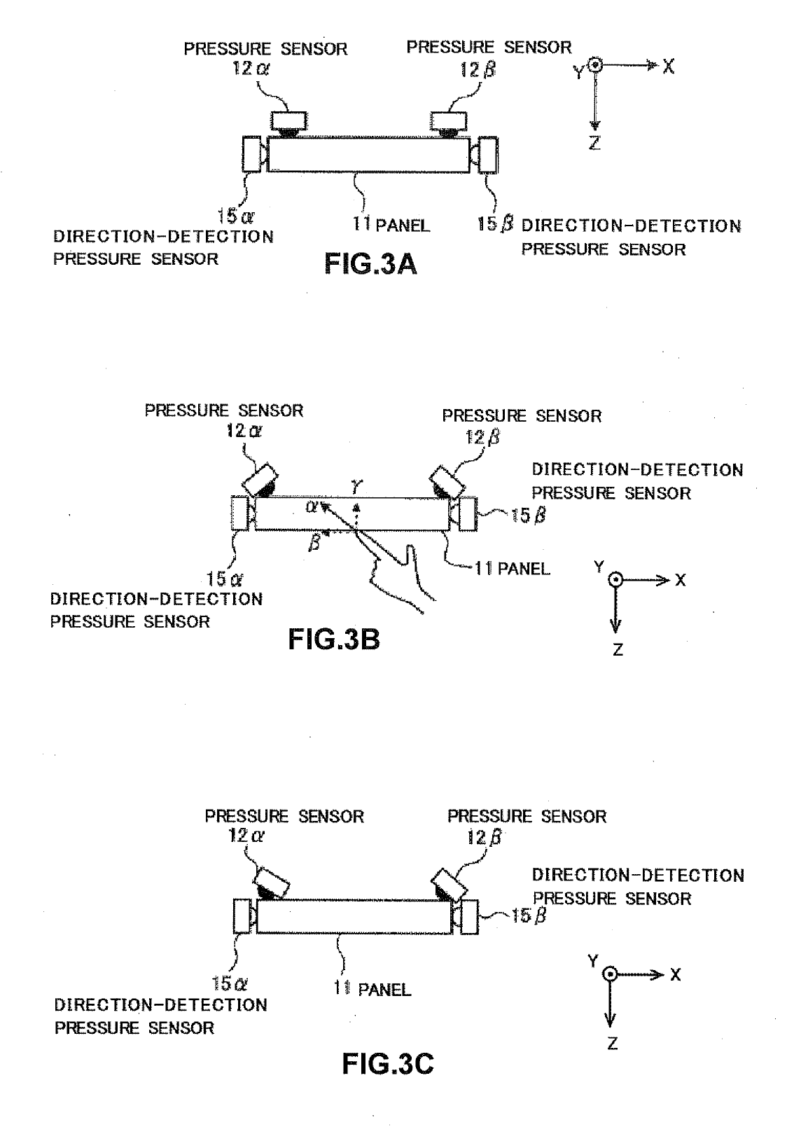

The installation locations of the pressure sensors 12 and a plurality of the direction-detection pressure sensors 15 are described based on FIGS. 3A, 3B and 3C. Each of FIGS. 3A, 3B and 3C shows an example of installation locations of the pressure sensors 12 and the direction-detection pressure sensors 15. Some parts of the description below use the coordinate axes indicated in the right side of FIGS. 3A, 3B and 3C when needed.

FIGS. 3A, 3B and 3C show the navigation apparatus 1 viewed from above. A pressure sensor 12α and a pressure sensor 12β are the upper (in a positive Y-axis direction) ones out of the pressure sensors 12 that are respectively installed at the four corners of the back of the panel 11.

As shown in FIG. 3A, the direction-detection pressure sensors 15 that include a direction-detection pressure sensor 15α and a direction-detection pressure sensor 15β are installed on the both sides of the right and the left edges of the panel 11.

On the configuration of the direction-detection pressure sensors 15 as above, the panel controller 18 can judge the pressing direction based on the pressure value detected by the direction-detection pressure sensor 15α and the pressure value detected by the direction-detection pressure sensor 15β.

In an example, the panel controller 18 judges that the pressing operation is done from the positive X-axis direction in the case where the pressure value detected by the direction-detection pressure sensor 15α is larger than the pressure value detected by the direction-detection pressure sensor 15β. On the other hand, the panel controller 18 judges that the pressing operation is done from the negative X-axis direction in the case where the pressure value detected by the direction-detection pressure sensor 15β is larger than the pressure value detected by the direction-detection pressure sensor 15α.

As above, the direction-detection pressure sensors 15 are installed at the two sides of the right and the left edges. However, the direction-detection pressure sensor 15 may be installed at one side of the right or the left edge. In this case, the panel controller 18 may judge the pressing direction based on the pressure value detected by the one direction-detection pressure sensor 15. On this configuration that has only one direction-detection pressure sensor 15, costs are reduced.

Here, the panel controller 18 judges the pressing direction by use of the direction-detection pressure sensors 15. However, the sensors for use are not limited to this type of the sensors. Other detection methods may be made by use of other types of sensors. In an example, the pressing direction with user's finger may be detected by an infrared sensor or an acoustic wave sensor, or the pressing direction is judged based on the image shot by a camera.

Moreover, as shown in FIG. 3B, the pressure sensors 12 may be installed at a prescribed angle to the surface of the panel 11. In the case where the pressing operation is done from the positive X-axis direction as shown in FIG. 3B, the pressure sensor 12α detects the stress shown as a vector α, and the direction-detection pressure sensor 15α detects the stress shown as a vector β.

The panel controller 18 derives a vector γ that indicates the stress from the front to the surface of the panel 11 based on the difference between the vector α and the vector β. Through this derivation, the panel controller 18 detects the pressing point closer to the center of the button. As shown in FIG. 3C, the pressure sensor 12α and the pressure sensor 12β may be installed at the same angle to the surface of the panel 11.

Here is a further description of the configuration of the navigation apparatus 1 based on FIG. 2. The communication I/F 16 is a communication device that transmits and receives communication data between the panel controller 18 and the main controller 27.

The memory 17 is a memory device, such as a nonvolatile memory, a hard disc drive or a standby RAM (Random Access Memory) being supplied power from a battery so as to be able to keep memory data even while an ignition switch is off. The memory 17 stores the correction values or the correction expression associated with the pressing directions and tilt angles as the correction table 17a. The memory 17 also stores the correction values adjusted by the correction-value adjuster 18a as the correction data 17b.

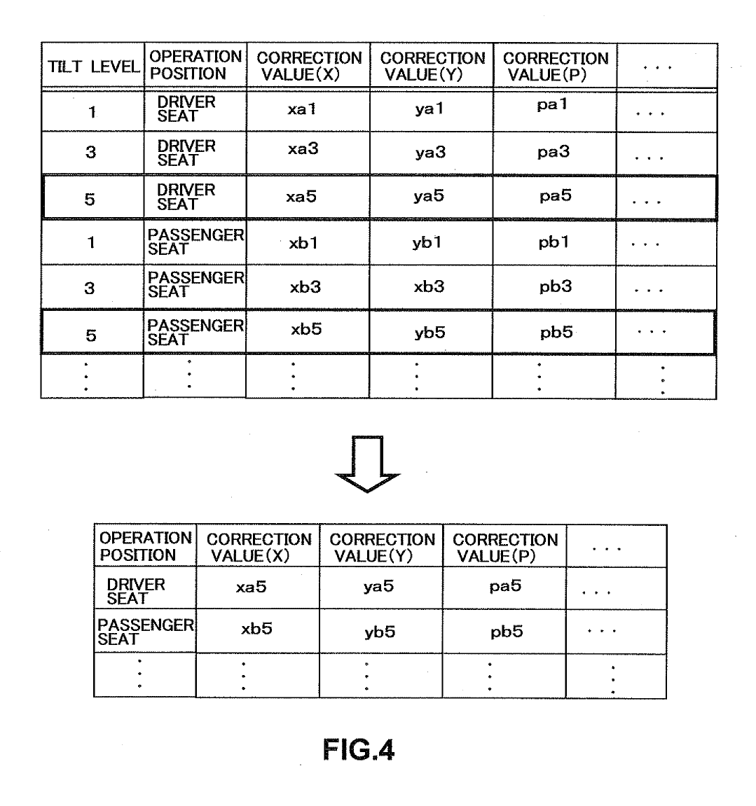

The details of the correction table 17a and the correction data 17b are described based on FIG. 4. FIG. 4 shows an example of the correction table 17a and an example of the correction data 17b. The upper table of FIG. 4 shows an example of the correction table 17a, and the lower table of FIG. 4 shows an example of the correction data 17b.

As shown in the upper table of FIG. 4, the correction table 17a includes the item of “tilt level,” the item of “operation position,” the item of “correction value (X),” the item of “correction value (Y)” and the item of “correction value (P).” The items of “correction value (X),” “correction value (Y)” and “correction value (P)” are stored in association with the items of “tilt level” and “operation position.” The correction table 17a is the aggregate of the records, each of which includes the items above.

The item of “tilt level” specifies the level corresponding to the prescribed tilt angle of the touch panel 10. The item of “operation position” specifies the pressing direction. When “driver seat” is indicated in the item of “operation position,” the pressing direction is a driver seat; the pressing operation is done from the direction of a driver seat. When “passenger seat” is indicated in the item of “operation position,” the pressing direction is a passenger seat; the pressing operation is done from the direction of a passenger seat.

The items of “correction value (X),” “correction value (Y)” and “correction value (P)” specify the correction values based on previously assumed values. The item of “correction value (X)” specifies a lateral correction value on the surface of the panel 11. The item of “correction value (Y)” specifies a vertical correction value on the surface of the panel 11. The item of “correction value (P)” specifies the correction value in terms of the pressing force.

The greater the touch panel 10 of a pressure sensitive system is tilted, the more the gravity makes an influence on the panel 11. Therefore, the pressure sensors 12 and the direction-detection pressure sensors 15 detect the pressure values influenced by the gravity when the pressing operation is done on the tilted panel 11.

Accordingly, the items of “correction value (X),” “correction value (Y)” and “correction value (P)” are associated with the tilt angle as well as the operation position so that the navigation apparatus 1 will not detect an erroneous pressing point by the influence of the gravity. Through this method, the navigation apparatus 1 accurately corrects the pressing point and the pressing force.

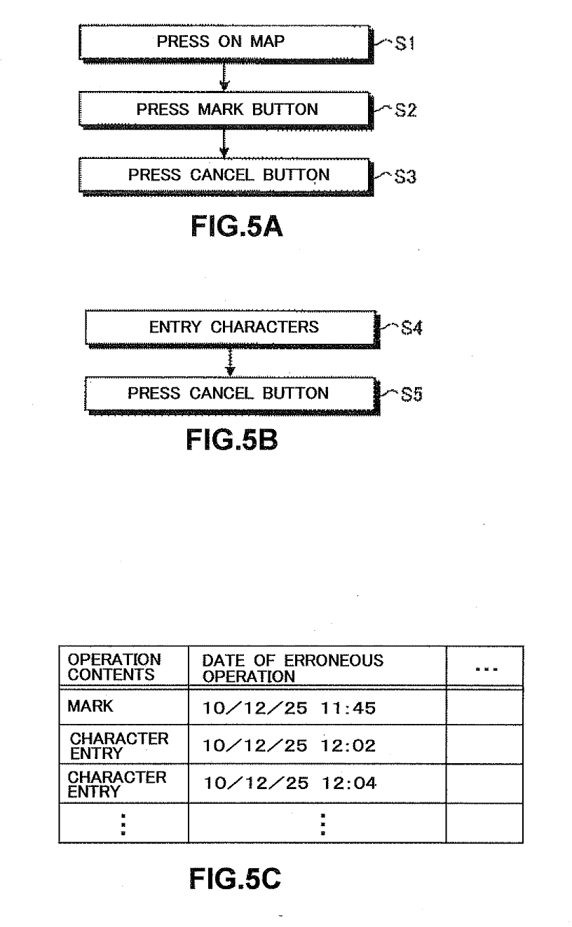

The correction-value adjuster 18a adjusts the values in the items of “correction value (X),” “correction value (Y)” and “correction value (P)” in order to improve the reliability of the correction values. Hereafter, the adjustment on the correction table 17a implemented by the correction-value adjuster 18a described above is referred to as “calibration.” The details of the calibration implemented by the correction-value adjuster 18a are described later based on FIG. 5.

As shown in the lower table of FIG. 4, the correction data 17b includes the items of “operation position,” “correction value (X),” “correction value (Y)” and “correction value (P).” When detecting the change in the tilt level, the correction-value adjuster 18a searches the record associated with the tilt angle received from the tilt-angle sensor 22 in the correction table 17a, picks up the appropriate record from the correction table 17a, and stores the picked up record as the correction data 17b.

As above, when detecting the change in the tilt level, the correction-value adjuster 18a stores the correction data 17b based on the correction table 17a. However, the data storage may be done at the time when the power of the navigation apparatus 1 is turned on or when the ignition switch is turned on.

In an example, when the tilt level of the surface of the panel 11 is changed to “5,” the correction-value adjuster 18a stores as the correction data 17b the record where “5” is indicated in the item of “tilt level” of the correction table 17a shown in the upper table of FIG. 4.

The correction table 17a of the example in FIG. 4 includes the correction values of the records where “1,” “3” and “5” are indicated in the item of “tilt level.” In the case where the record of the tilt level of the surface of the panel 11 is not stored in the correction table 17a, the correction-value adjuster 18a derives the correction values corresponding to the tilt level by using, for example, a linear interpolation method based on the correction values of the tilt level stored in the correction table 17a.

In the case where the tilt level corresponds to “2,” the correction-value adjuster 18a derives the average values of the correction values corresponding to the tilt level “1” and the tilt level “3” in the correction table 17a, and takes the derived values as the correction values corresponding to the tilt level “2.”

As for the method for derivation of the correction values not stored in the correction table 17a, averaging of the correction values corresponding to other tilt levels may be adopted, or other methods may be adopted. Or, the navigation apparatus 1 may store the correction values corresponding to all the tilt levels in the correction table 17a.

In the example shown in FIG. 4, the correction values (X), (Y) and (P) are stored in association with the items of “tilt level” and “operation position.” However, an arithmetic expression for correction, not the correction values, may be stored.

The correction-value adjuster 18a stores the correction data 17b by the methods above. As a result, as shown in the lower table of FIG. 4, the correction values (X), (Y) and (P) associated with “driver seat” indicated in the item of “operation position” are xa5, ya5 and pa5 respectively. The correction values (X), (Y) and (P) associated with “passenger seat” indicated in the item of “operation position” are xb5, yb5 and pb5 respectively. Then, the corrector 18d corrects the pressing point based on the correction values stored in the correction data 17b.

Here are a further description of the configuration of the navigation apparatus 1 based on FIG. 2, and a detailed description of the calibration implemented by the correction-value adjuster 18a. The panel controller 18 that controls the entirety of the touch panel 10, for example, corresponds to a panel microprocessor.

The correction-value adjuster 18a is a processor that adjusts the correction values (calibration) of the correction table 17a as initial adjustment at the time when the ignition switch is turned on after the navigation apparatus 1 is installed in a vehicle. The calibration includes the adjustment of the pressing point and the pressing force.

The pressing point is adjusted as follows. The correction-value adjuster 18a allows the panel 11 set at a prescribed tilt level to display a reference point such as a reference button or an arrow so as to prompt a user to press it. Then, the correction-value adjuster 18a derives the difference between the pressing point pressed by the user and the center of the reference button, and adjusts and updates the correction values (X) and (Y) in the correction table 17a corresponding to the set tilt level.

In the processing of the calibration described above, the correction-value adjuster 18a allows the panel 11 to display the reference point. However, the processing of the calibration is not limited to this. A transparent sticker or sheet that indicates a reference point may be previously attached on the front of the panel 11 to prompt a user to press the reference point.

The pressing force is adjusted based on the actual pressing force by user's sensory pressing action. First, the correction-value adjuster 18a allows the panel 11 to display “strong pressure,” “medium pressure” and “gentle pressure” for each of the tilt levels, and prompts the user to press the panel 11.

Then, the correction-value adjuster 18a adjusts and updates the correction value (P) of the correction table 17a based on each of the pressing forces applied by the user.

The calibration is preferable at all the tilt levels. However, there is another method; the calibration is carried out at some of the tilt levels, and the correction values corresponding to the rest of the tilt levels are adjusted by a linear interpolation method or the like.

The calibration carried out by the correction-value adjuster 18a updates the correction table 17a. However, the default values before the calibration may be separately stored in the memory 17 as the default correction values. This enables the correction table 17a to be initialized from the updated correction values to the default correction values in response to receipt of initialization operation to the correction table 17a.

Moreover, the correction-value adjuster 18a may carry out the calibration in the case where a user changes the tilt angle while the power of the navigation apparatus 1 is on or the ignition key is on, or where the correction-value adjuster 18a judges that it frequently receives erroneous operations.

Here is a description of the method of the judgment done by the correction-value adjuster 18a on whether or not it frequently receives the erroneous operations, based on FIGS. 5A, 5B and 5C. FIGS. 5A, 5B and 5C describe the timing for adjustment of the correction values. The example shown in FIGS. 5A, 5B and 5C indicates the case where the operation apparatus of the invention is applied to the navigation apparatus 1 that includes a navigation function.

The navigation function includes the operation of “Mark” for registering the location pressed by a user on a map as a mark, and the operation of “Destination” for registering as a destination the place specified through character entry.

As shown in FIG. 5A, the procedure for the operation of Mark is as follows; a certain location on the map is pressed (step S1), a button of Mark is pressed (step S2), and then a button of Cancel is pressed (step S3).

As the reason why the button of Cancel is pressed at the step S3, a user may have wanted to stop the operation of Mark. Or, the navigation apparatus 1 may have detected a location different from the location that the user wants to register.

As shown in FIG. 5B, the procedure for the operation of Destination is as follows; character buttons displayed on the panel 11 are pressed for character entry (step S4), and then the button of Cancel is pressed (step S5).

As the reason why the button of Cancel is pressed, the user may have mistyped or the navigation apparatus 1 may have recognized the character different from the one that the user has wanted to enter.

Therefore, in the case where the button of Cancel is pressed, the navigation apparatus 1 recognizes that erroneous operation has been performed, and stores the contents and the date of the erroneous operation as erroneous operation history.

The correction-value adjuster 18a judges that correction-value adjustment is needed in the case where the frequency of the erroneous operation (number of the erroneous operations performed in a prescribed period, or number of the erroneous operations out of the prescribed number of the operations) exceeds a prescribed threshold value based on the erroneous operation history. In this case, the correction-value adjuster 18a sends a message that prompts a user for start of the calibration.

This prevents the erroneous detection even when the panel 11 is pressed by the user that tends to press an area off the pressing point that has been adjusted based on the correction values stored in the correction data 17b. In the case of a new driver, the correction-value adjuster 18a also sends a message that prompts a user for start of the calibration, and the performed calibration prevents the erroneous detection.

Here is a further description of the configuration of the navigation apparatus 1 based on FIG. 2. The filter 18b cuts for each of the pressure sensors 12 the noises included in the pressure value detected by each of the pressure sensors 12. The filter 18b attenuates a prescribed frequency component based on the pressure value. The noise relates to the disturbance in the pressure value due to vibrations occurred on a moving vehicle.

Concretely, the signal generated by such an operation contains many low-frequency components compared to the components of the signal generated by a vehicle. This is because there are limitations to the speeds of such an operation and a repeat operation performed by a user. Thus, the filter 18b may cut the noises by use of a LPF (Low pass filter) that removes high-frequency components or by another method.

The filter 18b also outputs to the deriving part 18c the pressure value after cutting the noises for each of the pressure sensors 12. The filter 18b may also cut the noises included in the pressure value detected by the direction-detection pressure sensor 15.

The deriving part 18c derives the pressing point based on the pressure values after noise cutting by the filter 18b and the relation among the detected values, such as the ratios among the values detected by the respective pressure sensors 12. The deriving method is known publicly and the description of the deriving method is cut out here. The deriving part 18c also outputs the derived pressing point to the corrector 18d.

The corrector 18d corrects the pressing point derived by the deriving part 18c, based on the correction data 17b associated with the pressing direction detected by the direction-detection pressure sensor 15.

In the embodiment, the pressing point is derived, and then the derived pressing point is corrected. However, the detected pressure values may be corrected based on the correction values corresponding to the respective pressure sensors 12 stored in advance, and the pressing point may be derived.

In some vehicle conditions (in a case of driving, etc.), a driver can not make any operations. In such a case, the corrector 18d may use only the correction values corresponding to “passenger seat” of the item of “operation position” regardless of the result detected by the direction-detection pressure sensor 15.

The panel driver 21 is a mechanical part that rotates the touch panel 10 in accordance with the instruction from the main controller 27. The panel driver 21 includes a motor and various gears. As above, on the navigation apparatus 1, the touch panel 10 is used in a variety of the tilt angles by use of the panel driver 21.

The tilt-angle sensor 22 detects the current tilt angle based on the output history of the drive-contents notice output by the panel driver 21.

Concretely, when detecting the current tilt angle, the tilt-angle sensor 22 outputs the detected tilt angle to the main controller 27. The main controller 27 outputs the tilt angle to the correction-value adjuster 18a of the panel controller 18 through the communication I/F 25.

The tilt-angle sensor 20 is not limited to this; the tilt-angle sensor 20 may include a rotary switch, a light sensor, or a potentiometer that detects the rotation angle of the axis of the motor not shown in FIG. 2.

The map DB 23 is map data for navigation that includes road data and facility data. The memory 24 includes a storage device such as a nonvolatile memory or a hard disc drive.

The communication I/F 25 is a communication device that transmits and receives communication data for the main controller 27 to and from the panel controller 18. The GPS receiver 26 receives the position data of own vehicle from satellites or the like, and outputs the received position data to the main controller 27.

The main controller 27 that controls the entire navigation apparatus 1 corresponds to a navigation microprocessor or the like. In an example, the main controller 27 changes the tilt angle of the touch panel 10 by driving the panel driver 21 based on the pressing point and pressing force received from the panel controller 18 through the communication I/F 25.

As above, the operation apparatus of the invention is applied to the navigation apparatus 1 that includes a navigation function, but not limited to the navigation apparatus 1. In another example, the operation apparatus of the invention may be applied to the operation apparatus of a TV set or the audio apparatus that replays CDs and/or DVDs.

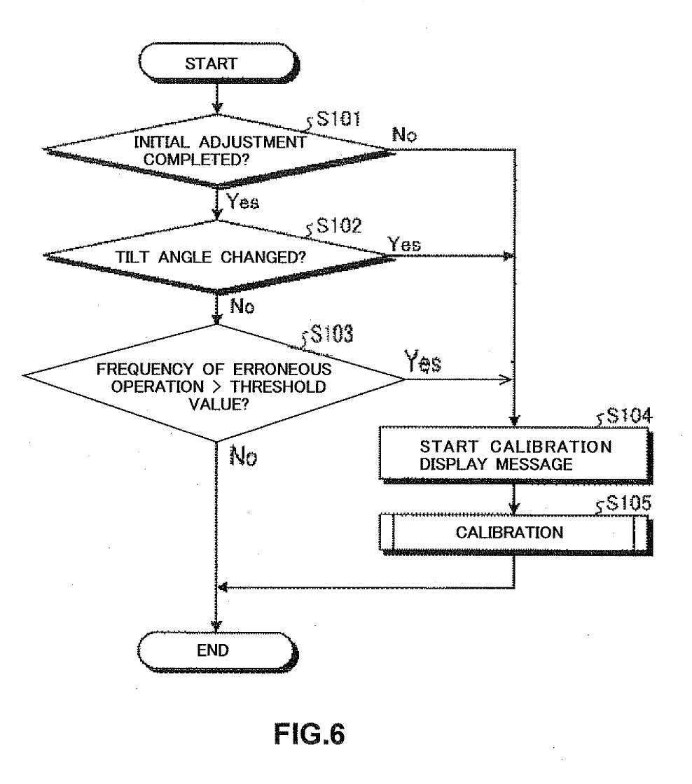

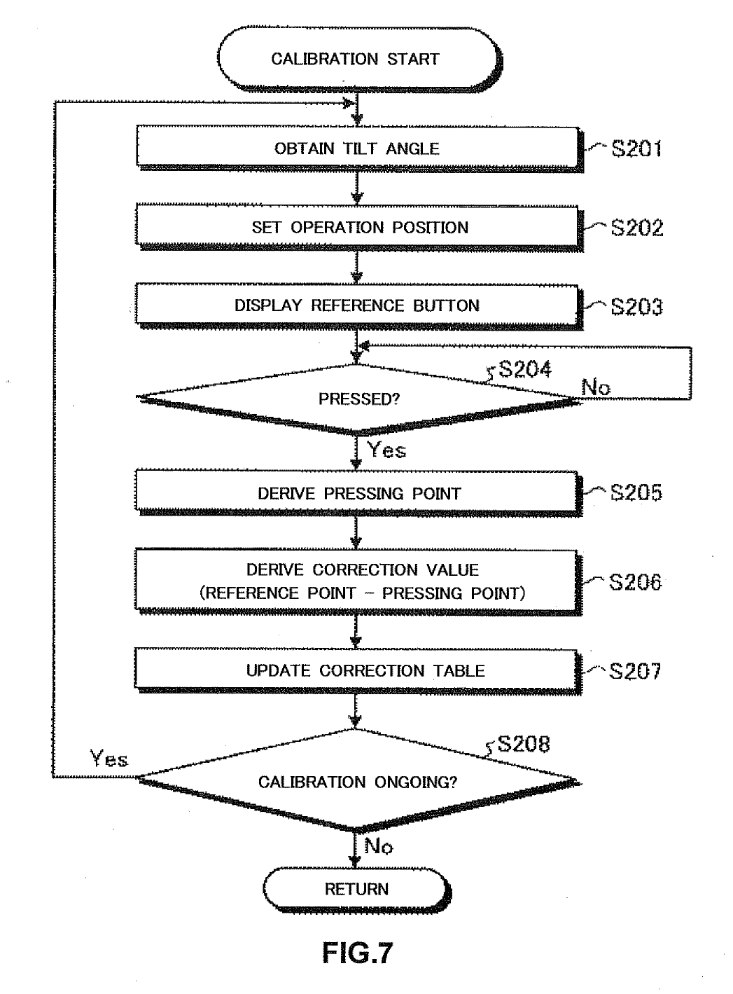

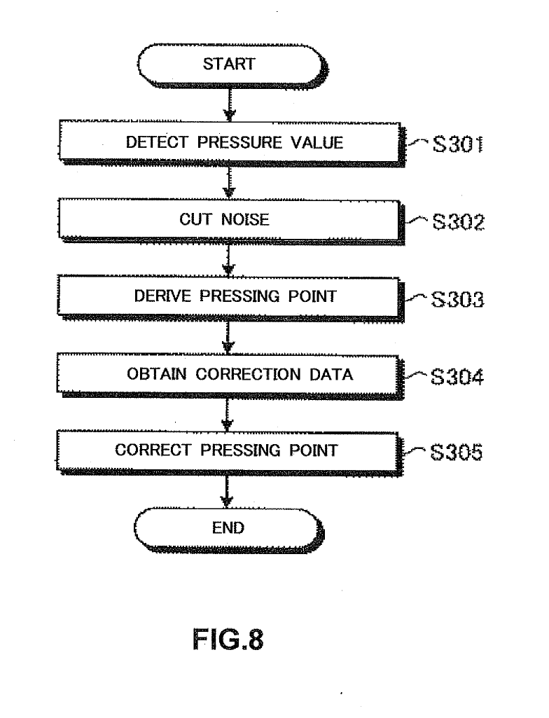

Next, here is a detailed description of the controls to the panel 11 implemented on the navigation apparatus 1 of the embodiment based on FIG. 6, FIG. 7 and FIG. 8. FIG. 6 shows an overview flowchart for timing decision. FIG. 7 shows an overview flowchart for correction value adjustment. FIG. 8 shows an overview flowchart for pressing point correction.

The controls to the panel 11 on the navigation apparatus 1 of the embodiment is implemented by the panel controller 18. However, the controls may be implemented by the main controller 27 (or may be implemented by the main controller 27 through the panel controller 18). The microprocessor included in the panel controller 18 makes the actual controls based on a program. For ease of understanding, the controls are, in the description, implemented by the respective functional components included in the panel controller 18.

The navigation apparatus I makes a timing decision for the calibration shown in FIG. 6 constantly at prescribed intervals while the power is on. First, the correction-value adjuster 18a judges whether the initial adjustment has been completed (step S101) as the initial adjustment normally is done at the time of installation of the navigation apparatus 1 in a vehicle.

In the judgment, the data of the fact that the initial adjustment has been done is sent through a backup line (a line directly connected to a battery) for example, to a memory for storage (the memory is erased by removing of the navigation apparatus 1 or the battery), and the correction-value adjuster 18a confirms the stored contents.

When judging that the initial adjustment has not been done (No at the step S101), the correction-value adjuster 18a sends a message for start of the calibration (step S104) and moves to the calibration (step S105).

When judging that the initial adjustment has been done (Yes at the step S101), the correction-value adjuster 18a judges whether the tilt angle has been changed (step S102).

When judging that the tilt angle has been changed (Yes at the step S102), the correction-value adjuster 18a sends the message for start of the calibration (step S104) and moves to the calibration (step S105).

When judging that the tilt angle has not been changed (No at the step S102), the correction-value adjuster 18a judges whether the frequency of the erroneous operations exceeds the prescribed threshold value (step S103).

When judging that the frequency of the erroneous operations exceeds the prescribed threshold value (Yes at the step S103), the correction-value adjuster 18a sends the message for start of the calibration (step S104) and moves to the calibration (step S105).

When judging that the frequency of the erroneous operations does not exceed the prescribed threshold value (No at the step S103), the correction-value adjuster 18a terminates the timing decision on a series of the calibration implemented by the correction-value adjuster 18a.

The details of the procedure for the calibration implemented by the panel controller 18 are described based on FIG. 7. As shown in FIG. 7, the correction-value adjuster 18a obtains the tilt angle through the communication I/F 16 from the tilt-angle sensor 22 (step S201).

Then, the correction-value adjuster 18a sets a driver seat or a passenger seat as the operation position. The operation position of this setting is specified by a user. When the operation position is set (step S202), the correction-value adjuster 18a allows the panel 11 to display a reference button (step S203).

Then, the correction-value adjuster 18a judges whether the reference button has been pressed by a user (step S204). When the correction-value adjuster 18a judges that the reference button has been pressed (Yes at the step S204), the deriving part 18c derives the pressing point (step S205).

When judging that the reference button has not been pressed (No at the step S204), the correction-value adjuster 18a repeats the judgment of the step S204 until the reference button is pressed.

The correction-value adjuster 18a derives as the correction values the difference between the center of the reference button and the derived pressing point at the step S205 (step S206), and updates the correction values in the correction table 17a to the correction values derived in association with the tilt angle and the operation position (step S207).

Then, the correction-value adjuster 18a judges whether the calibration is continued based on user's operation of “termination” or “ongoing” (step S208). When receiving the operation of “ongoing” (Yes at the step S208), the correction-value adjuster 18a moves to the calibration of the step S201. When receiving the operation of “termination” (No at the step S208), the correction-value adjuster 18a terminates the series of the calibration.

Next, the details of the correction procedure of the pressing point implemented by the panel controller 18 are described based on FIG. 8. When receiving the pressing operation, the panel controller 18 implements the correction procedure. As shown in FIG. 8, a plurality of the pressure sensors 12 detect pressure values (step S301).

The filter 18b cuts the noises included in the pressure values detected by the plurality of the pressure sensors 12 (step S302).

Then, the deriving part 18c derives the pressing point based on the respective pressure values after noise cut (step S303). The corrector 18d obtains the correction data 17b associated with the pressing direction detected by the direction-detection pressure sensor 15 (step S304).

Then, the corrector 18d corrects the pressing point derived by the deriving part 18c based on the correction data 17b (step S305), and terminates a series of the correction of the pressing point implemented by the panel controller 18. The panel controller 18 transmits to devices and apparatus having various functions the data of the pressing point corrected by the corrector 18d, not shown in figures.

As above, the navigation apparatus 1 of the embodiment derives the pressing point based on the pressure values detected by the pressure sensors 12 set at the four corners of the back of the panel 11, and corrects the derived pressing point in accordance with the pressing direction. This prevents the erroneous detection of the pressing point even when the navigation apparatus 1 of the embodiment is pressed from a diagonal direction to the surface of the panel 11.

In the embodiment described above, the correction-value adjuster 18a adjusts the correction values in the correction table 17a associated with the tilt angle and the pressing direction by the calibration. In the calibration, the correction-value adjuster 18a obtains the correction data 17b from the adjusted correction table 17a, and corrects the pressing point and the pressing force based on the obtained correction data 17b.

However, the method of adjusting the correction values is not limited to this. In an example, the panel controller 18 may have a learning function so as to obtain the correction values, and the correction data 17b may be adjusted based on the correction values obtained through the learning function.

Next, the modification of the method of adjusting the correction data 17b is described based on FIG. 9. FIG. 9 describes a learning function in terms of the correction values. The modification describes the case where the pressing direction is a driver seat and the correction values of the correction value (X) are only specified.

As ST1 in FIG. 9 shows, the panel controller 18 initializes at a prescribed time the correction value (X) of the correction data 17b into “0.” The right time to initialize the correction value (X) of the correction data 17b may be when the navigation apparatus 1 is installed in a vehicle, the power of the navigation apparatus 1 is turned on, or an ignition switch is turned on.

Then, the panel controller 18 makes a fine adjustment of the correction value (X) of the correction data 17b when the difference in positions between the center of the operation button and the corrected pressing point is less than a prescribed threshold, or the corrected pressing point is inside the area of the operation button. The fine adjustment is made so that the corrected pressing point is brought in closer alignment with the center of the operation button.

When the operation is cancelled, the adjustment in the positions between the pressing point and the operation button to be selected by a user is not expected. Thus, the panel controller 18 does not make any fine adjustment.

ST1 in FIG. 9 shows an example that the difference in positions between the center of the operation button and the corrected pressing point is “5” (the center of the button−corrected pressing point=5). The difference is obtained as follows; a prescribed operation button is pressed by a user, and the pressing point is corrected by use of the value “0” as the correction value (X).

Under the precondition that the fine adjustment is made when the difference between the center of the button and the corrected pressing point is 10 or less, since the difference is 5 and less than 10, the panel controller 18 makes the fine adjustment of the correction value (X).

In terms of the fine adjustment of the correction value (X), the panel controller 18 adds to the correction value (X) the adjustment value per change, for example “1.” Here, the panel controller 18 does not use the value “5” of the actual difference between the center of the button and the corrected pressing point. (Refer to ST2 in FIG. 9.)

When the operation button is pressed, the panel controller 18 again makes the fine adjustment of the correction value (X) based on the difference between the center of the operation button and the pressing point corrected which is corrected by the value “1” that is previously fine adjusted value of the correction value (X) (refer to ST3 in FIG. 9).

In such a manner, the panel controller 18 repeats the fine adjustment of the correction value (X) until the correction data 17b becomes the value “5” as shown in ST4 of FIG. 9. As a result, the method accurately adjusts the correction value (X) for the case where the pressing operation is done from the direction of a driver seat. That is, the navigation apparatus 1 can prevent the erroneous detection of the pressing point.

The panel controller 18 initializes at the prescribed time the correction value (X) of the correction data 17b into “0.” However, the panel controller 18 may make the fine adjustment of the correction value (X) of the correction data 17b obtained from the correction table 17a instead of initialization.

While the invention has been shown and described in detail, the foregoing description is in all aspects illustrative and not restrictive. It is therefore understood that numerous other modifications and variations can be devised without departing from the scope of the invention.

What is claimed is:

1. An operation apparatus that receives a pressing operation by a user on a surface of a touch panel, the operation apparatus comprising:
a plurality of detectors that detect pressure values at a plurality of positions of the touch panel, the pressure values being generated at a time of the pressing operation;
a controller configured to drive a pressing point based on the pressure values detected by the detectors; and
a first memory that stores pressing point correction data to correct the derived pressing point in association with a pressing direction relative to the surface of the touch panel,
wherein the controller is configured to correct the derived pressing point based on the pressing point correction data stored in the first memory.

2. The operation apparatus of claim 1, wherein:
the controller is configured to derive a pressing force based on the pressure values detected by the detectors;
the operation apparatus further comprises a second memory that stores pressing force correction data to correct the derived pressing force in association with the pressing direction relative to the surface of the touch panel; and
wherein the controller is configured to correct the derived pressing force based on the pressing force correction data stored in the second memory.

3. The operation apparatus of claim 1, further comprising:
a tilt angle detector that detects a tilt angle of the touch panel, wherein
the first memory stores the pressing point correction data in association with the tilt angle of the operation apparatus, and
the controller is configured to correct the pressing point based on the pressing point correction data corresponding to the tilt angle detected by the tilt angle detector.

4. The operation apparatus of claim 1, further comprising:
a display that displays a reference pressing point for generating correction data;
wherein the controller is configured to generate the pressing point correction data based on a positional relation between the reference pressing point and the pressing point derived by the controller.

5. The operation apparatus of claim 1, wherein:
the controller is configured to adjust the pressing point correction data based on a positional relation between the derived pressing point corrected by the controller and a reference pressing point set with respect to an operation content corresponding to the pressing point.

6. The operation apparatus of claim 1, further comprising:
a pressing direction detector that detects the pressing direction relative to the surface of the touch panel, wherein
the controller is configured to correct the pressing point based on the pressing point correction data corresponding to the pressing direction detected by the pressing direction detector.

7. An operation apparatus that receives a pressing operation by a user on a surface of a touch panel, the operation apparatus comprising:
a plurality of detectors that detect pressure values at a plurality of locations of the touch panel, the pressure values being generated at a time of the pressing operation;
a controller configured to derive a pressing force based on the pressure values detected by the detectors; and
a memory that stores pressing force correction data to correct the derived pressing force in association with a pressing direction relative to the surface of the touch panel,
wherein the controller is configured to correct the derived pressing force based on the pressing force correction data stored in the memory.

8. The operation apparatus of claim 7, wherein:
the controller is configured to derive a pressing point based on the derived pressing force corrected by the controller;
the operation apparatus further comprises a second memory that stores pressing point correction data to correct the derived pressing point in association with the pressing direction relative to the surface of the touch panel;
wherein the controller is configured to correct the derived pressing point based on the pressing point correction data stored in the second memory.

9. A computer-implemented correction method of correcting a value derived based on a pressing operation by a user on a surface of a touch panel, the correction method comprising the steps of:
(a) detecting pressure values at a plurality of positions of the touch panel, the pressure values being generated at a time of the pressing operation;
(b) deriving a pressing point based on the pressure values detected at the step (a); and
(c) correcting the derived pressing point based on pressing point correction data to correct the derived pressing point, the pressing point correction data being associated with a pressing direction relative to the surface of the touch panel.

10. The correction method of claim 9, further comprising the steps of
(d) deriving a pressing force based on the pressure values detected at the step (a); and
(e) correcting the derived pressing force based on pressing force correction data to correct the derived pressing force, the pressing force correction data being associated with the pressing direction relative to the surface of the touch panel.

11. The correction method of claim 9, further comprising the step of:
(f) detecting a tilt angle of the touch panel, wherein
the step (c) corrects the derived pressing point based on the tilt angle detected at the step (f) and the pressing point correction data associated with the tilt angle of the touch panel.

12. The correction method of claim 9, further comprising the steps of:
(g) on a display, displaying a reference pressing point for generating correction data; and
(h) generating the pressing point correction data based on a positional relation between the reference pressing point and the pressing point derived at the step (b).

13. The correction method of claim 9, further comprising the step of:
(i) adjusting the pressing point correction data based on a positional relation between the pressing point corrected at the step (c) and a reference pressing point set with respect to an operation content corresponding to the pressing point.

14. The correction method of claim 9, further comprising the step of:
(j) detecting the pressing direction relative to the surface of the touch panel, wherein
the step (c) corrects the derived pressing point based on the pressing point correction data corresponding to the pressing direction detected at the step (j).

15. A computer-implemented correction method of correcting a value derived based on a pressing operation by a user on a surface of a touch panel, the correction method comprising the steps of:
(a) detecting pressure values at a plurality of locations of the touch panel, the pressure values being generated at a time of the pressing operation;
(b) deriving a pressing force based on the pressure values detected at the step (a); and
(c) correcting the derived pressing force based on pressing force correction data to correct the derived pressing force, the pressing force correction data being associated with a pressing direction relative to the surface of the touch panel.

16. The correction method of claim 15, further comprising the steps of:
(d) deriving a pressing point based on the pressing force corrected at the step (c); and
(e) correcting the derived pressing point based on pressing point correction data to correct the derived pressing point, the pressing point correction data being associated with the pressing direction relative to the surface of the touch panel.

17. A non-transitory computer-readable recording medium that stores a program executable by a computer included in an operation apparatus that receives a pressing operation by a user on a surface of a touch panel, the program causing the computer to execute the steps of:
(a) detecting pressure values at a plurality of positions of the touch panel, the pressure values being generated at a time of the pressing operation;
(b) deriving a pressing point based on the pressure values detected at the step (a); and
(c) correcting the derived pressing point based on pressing point correction data to correct the derived pressing point, the pressing point correction data being associated with a pressing direction relative to the surface of the touch panel.

18. A non-transitory computer-readable recording medium that stores a program executable by a computer included in an operation apparatus that receives a pressing operation by a user on a surface of a touch panel, the program causing the computer to execute the steps of:
(a) detecting pressure values at a plurality of locations of the touch panel, the pressure values being generated at a time of the pressing operation;
(b) deriving a pressing force based on the pressure values detected at the step (a); and
(c) correcting the derived pressing force based on pressing force correction data to correct the derived pressing force, the pressing force correction data being associated with a pressing direction relative to the surface of the touch panel.

19. The non-transitory computer-readable recording medium of claim 18, the program causing the computer to execute the further steps of:
(d) deriving a pressing point based on the pressing force corrected at the step (c); and
(e) correcting the derived pressing point based on pressing point correction data to correct the derived pressing point, the pressing point correction data being associated with the pressing direction relative to the surface of the touch panel.
